(19) United States
(12) Patent Application Publication
(10) Pub. No.: US 2007/0131826 A1
(43) Pub. Date: Jun. 14, 2007

(54) Articulated leveling and point support fitting

(76) Inventor: George D. Valkai, Astoria, NY (US)

Correspondence Address: LADAS & PARRY, 26 WEST 61ST STREET, NEW YORK, NY, 10023, US

(21) Appl. No.: 11/636,290

(22) Filed: Dec. 8, 2006

Related U.S. Application Data
(60) Provisional application No. 60/748,741, filed on Dec. 9, 2005.

(51) Int. Cl. F16M 11/24; F16M 7/00

(52) U.S. Cl. 248/188.4; 248/650

(57) ABSTRACT

An articulated point support fitting has a cup with a first hole at one end for a fastener to the support and an opening at an opposite end, a barrel secured to the cup at one end and arcuate at the opposite end with a second hole therethrough, and a dome washer with a third hole therethrough on the outside of the arcuate barrel end. A spring in the cup holds a dome nut against the inside of the arcuate barrel end for receiving a second fastener through the second and third holes to hold on a structure that retains an article against the dome washer.

### BACKGROUND OF THE INVENTION

Field of the Invention

This invention relates generally to the field of apparatus for industrial or architectural load transferring and bearing device (hardware) such as glass panels or other solid material's attachment to base structure. Such as railing, wall panel or other structural applications and precision leveling support for generic applications. Moreover it pertains specifically to such apparatus for mounting glass, metal or other solid materials as railing, ceiling or wall panels, mounting and precision leveling of objects or machinery to uneven surface, structure or substrate.

### SUMMARY OF THE INVENTION

In view of the limitations now present in the prior art, the present invention provides a new and useful load bearing and transferring, articulated leveling and point supporting device for architectural and/or industrial, etc. applications. Incorporating X, Y and Z-axis movements and self leveling or pre-positioned angular adjustments of supporting plane, as such transferring loads at optimum surface contact which is simpler in construction, more universally usable and more versatile in operation than known apparatus of this kind.

The purpose of the present invention is to provide a new load bearing and transferring, articulated leveling and point supporting device for architectural, industrial, etc. applications. Incorporating X, Y and Z-axis movements and self leveling or pre-positioned angular adjustments of supporting plane, as such transferring loads at optimum surface contact, a device that has many novel features not offered by the prior art apparatus that result in a new load bearing and transferring, articulated leveling and point supporting device incorporating X, Y and Z-axis movements and self leveling or pre-positioned angular adjustments of supporting plane, as such transferring loads at optimum surface contact, a device which is not apparent, obvious, or suggested, either directly or indirectly by any of the prior art apparatus.

The present invention generally comprises eleven components in two groups. The base contains a cylindrical barrel (A) with inner thread which screws over an outer threaded mounting cup (B).

The cup has an open end and a base with an oversized mounting hole which is attached to the mounting surface/base structure via a standard hex socket cap screw (C) and a pair of sized fender washers (D)—one larger at the base and one smaller at the top. The two washers' combination provides full transfer load at the advantage of being able to shift their individual axis lines in reference to the cup's axis placement (X and Z axis movement). This configuration allows the cup and barrel assembly to be variably positioned over an existing or not accurately positioned thread or thru hole. If thru bolted, the retaining washer and nut should be applied to complete the mounting process. The full movement can vary according to overall size of assembly and specific application, approximate range of circular movement is a ½″ radius around the point of axis.

The barrel's top surface is dome shaped at the inner (convex) and outer (concave) sides. The inner convex dome surface accepts a concave faced washer the dome nut (E) this is held in place with a compression spring (F) loaded against the base cup. The dome nut has a perimeter flange to act as stop for the spring and a threaded hole at the center to fasten the mountable object/glass onto it. The spring provides constant pressure against the inner (convex) dome surface. The assembled base barrel contains the followings: a cap screw, 2 fender washers, cup, compression spring and the dome nut and closed via internal/external full threading.

The amount of thread being utilized can accommodate the Y axis (vertical) movement thru turning it deeper (in) over the cup or raising it higher (out).

The full movement can be customized for different thickness or applications.

The dome nut is always positioned tight against the barrel's convex surface via the compression spring. This allows repeated removal/installation and/or repositioning process without taking apart the whole unit.

The barrels' convex radius is slightly larger than the dome nuts' concave radius in order to “bite” into the convex dome surface during final tightening. This also prevents the rotation of the two surfaces during threading and tightening.

The second group is containing two shaped nylon washers, retaining disc (I) and fastener (J).

The mounted barrel assembly (one or several pieces can be used as required by design and load requirements) is accepting the dome washer #1 (G), which sits inside the barrel's matching, concave surface. Clearance around the perimeter flange allows a calibrated tilt angle adjustment in 360 degree (here +/−4 degrees). If the fittings are used in unison on a single pane of glass or work piece, their cumulative effect is less than the individual component's nominal value. The dome washer (nylon or various other material) to be designed according to load/transfer requirements and compatibility with the mounted materials itself.

The washers to be attached with a small amount of adhesive (such as silicone) to the glass or other materials to hold it in place for the duration of installation. The glass or other material that is to be mounted, one side is equipped with the dome washer #1, the opposite surface receives the flat washer #2 (H) this is to be attached with the same adhesive. A stainless steel (or other) retaining disc is completing the whole assembly thru a flathead socket cap screw (J) into the dome nut.

The fixture requires two bolts for each connection. The base fastener (C) is approached thru the barrel's concave opening reaching in with a ball head T-handle hex key. The barrel/s self aligned thru the nylon spacers, eliminating all additional need for measurement. Once tightened base can accommodate the closure flat washer #2 (I) with the retainer disc and fasten the whole assembly with the flathead screw into the inner dome nut.

The above has outlined, in general, the physical aspects of the invention and is to serve as an aid to better understanding the complete detailed description. In reference to such, there is to be a clear understanding that the present invention is not limited to the method or detail of construction, fabrication, material, or application of use described and illustrated herein. Any other variation of fabrication, use, or application should be considered apparent as an alternative embodiment of the present invention.

### Method of Use

The articulated point support device is having two groups of components. The preassembled base mount is to be attached hand tight to the supporting structure with the provided bolt. Prepare the work piece (glass) by mounting the dome and flat washers on the glass with a small amount of clear adhesive. Align the glass piece with the hand tight base fittings, align/match all axis locations. This time make all necessary movements of the pre-positioned fittings through their X and Y axis shifts, raise or lower the top surfaces as required to provide a uniform seating surface at each fittings. Hold glass piece steady in final position. Tighten the base mount onto the structure with the Allen key through the glass in place.

The dome washers are providing the final tilt adjustments, seating all fittings fully within the concave dome surfaces, assuring uniform surface contact and load bearing without peak stress points.

The retainer assembly consists the disc and flat head screw. Lead the fastener thru the glass and washers and thread into dome nut. Tighten with the Allen key to complete installation.

Should the need arise to replace the glass or further adjustments are necessary, loosen all top fasteners and repeat above procedure.

### OBJECTS OF THE INVENTION

Accordingly several advantages and objects of the present invention are:

A principal object of the present invention is to provide a simple way to mount and adjust objects over a fixed fastening location by the means of shifting, tilting and raising/lowering the hardware and it's load transferring platform will overcome the deficiencies of the prior art devices.

An object of the present invention is to provide a lateral movement X and Y coordinates and their combination thereof. Device that is shifting over a fixed mounting location such as hole or threaded hole in a circular field.

Another object of the present invention is to provide a vertical movement via Z coordinate to provide depth adjustment. Device that is moving its' top surface forward or backward.

Another object of the present invention is to provide an angle adjustment to correct angular misalignment between mounting and mounted surfaces or doing so between several points. Device that is tilting around a full circle in +/−4 degrees (or other determined angle) to correct out base plane and mounted glass' desired plane discrepancies.

Another object of the present invention is to provide a hardware positioning system as directed by determined mounting locations of the glass holes or mounting holes. Device that is mounted and fastened through the hole in the glass via an Allen Key.

Another object of the present invention is to provide an alignment between glass panels or other materials in line, curve or shape, direction as set by design. Device that is adjustable to bring Z coordinates into line, curve or shape by individually adjusting their dept.

Another object of the present invention is to provide a stress free mounting of the glass in a parallel plane to the hardware. Device that is self-aligning the dome shaped washer to transfer thru maximum surface contact without peak stress areas.

Another object of the present invention is to provide re-adjustability of hardware, glass location and their planes' fine adjustments. Device that is incorporating all 3 axis movements to allow repeat installation and removal of hardware, repeat shift, depth and angle adjustment to fine tune for precise alignment, positioning and parallel placement of glass or other work piece.

Another object of the present invention is to provide a device that incorporates all parts and fastener for simple, organized workflow. Device that is containing all of the followings: spring loaded retainer dome nut, washers, and fastener in one piece. Fitting can be installed prior to aligning glass panels. Positioned by glass and tighten at final location.

Another object of the present invention is to provide a compact unit to achieve all movements and present an architecturally aesthetic hardware. Device that is measuring approximately 2″×2″ block size having all movements & parts concealed in a contemporary metal body.

Another object of the present invention is to provide a glass layout that could be changed or modified for better alignment, enhanced structural integrity and refined look. Device that is securing the glass or other work pieces in a configuration which can be realigned, changed, that is more universally functional in today's market than the prior art devices without breaking permanent connections between glass, hardware and base surface. Removable system, reusable all components.

It is intended that any other advantages and objects of the present invention that become apparent or obvious from the detailed description or illustrations contained herein are within the scope of the present invention.

### BRIEF DESCRIPTION OF THE DRAWINGS

The following drawings further describe by illustration the advantages and objects of the present invention. Each drawing is referenced by corresponding figure reference characters within the “DETAILED. DESCRIPTION OF THE INVENTION” section to follow.

FIG. 1. is a perspective view of the Articulated Point Support Fitting according to the present invention.

FIG. 2. is a front view of the Articulated Point Support Fitting according to the present invention.

FIG. 3 is a rear view of the Articulated Point Support Fitting according to the present invention.

FIG. 4 is a side view of the Articulated Point Support Fitting according to the present invention.

FIG. 5 is a cross sectional view of the Articulated Point Support Fitting according to the present invention in base condition. Seen in FIG. 4, taken along line 4-4 of that drawing.

FIG. 6 is a cross sectional view of the Articulated Point Support Fitting according to the present invention in a combined tilt and shift condition. Seen in FIG. 4, taken along line 4-4 of that drawing.

FIG. 7. is an axonometric view of the Articulated Point Support Fitting according to the present invention in a base condition.

FIG. 8A, 8B, 8C. are an elevation, section and plan view of the Articulated Point Support Fitting as applied in field according to the present invention.

### DETAILED DESCRIPTION OF THE INVENTION

Referring now descriptively to the drawings, the attached figures illustrate the Articulated Point Support Fitting.

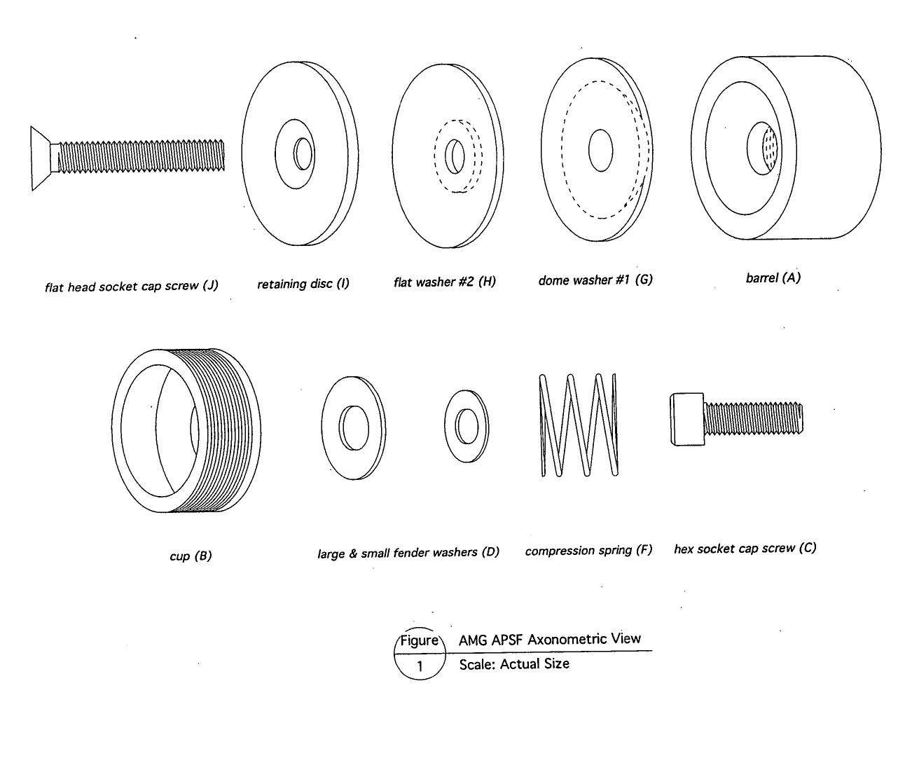

FIG. 1. Illustrates the Articulated Point Support Fitting according to the present invention in an exploded view with each particular component.

The purpose of the present invention is to provide a load bearing and transferring, articulated leveling and point supporting device for architectural, industrial, etc. applications. Incorporating X, Y and Z-axis movements and self leveling or pre-positioned angular adjustments of supporting plane, as such transferring loads at optimum surface contact, a device that has many novel features not offered by the prior art apparatus that result in a new load bearing and transferring, articulated leveling and point supporting device incorporating X, Y and Z-axis movements and self leveling or pre-positioned angular adjustments of supporting plane, as such transferring loads at optimum surface contact, a device which is not apparent, obvious, or suggested, either directly or indirectly by any of the prior art apparatus.

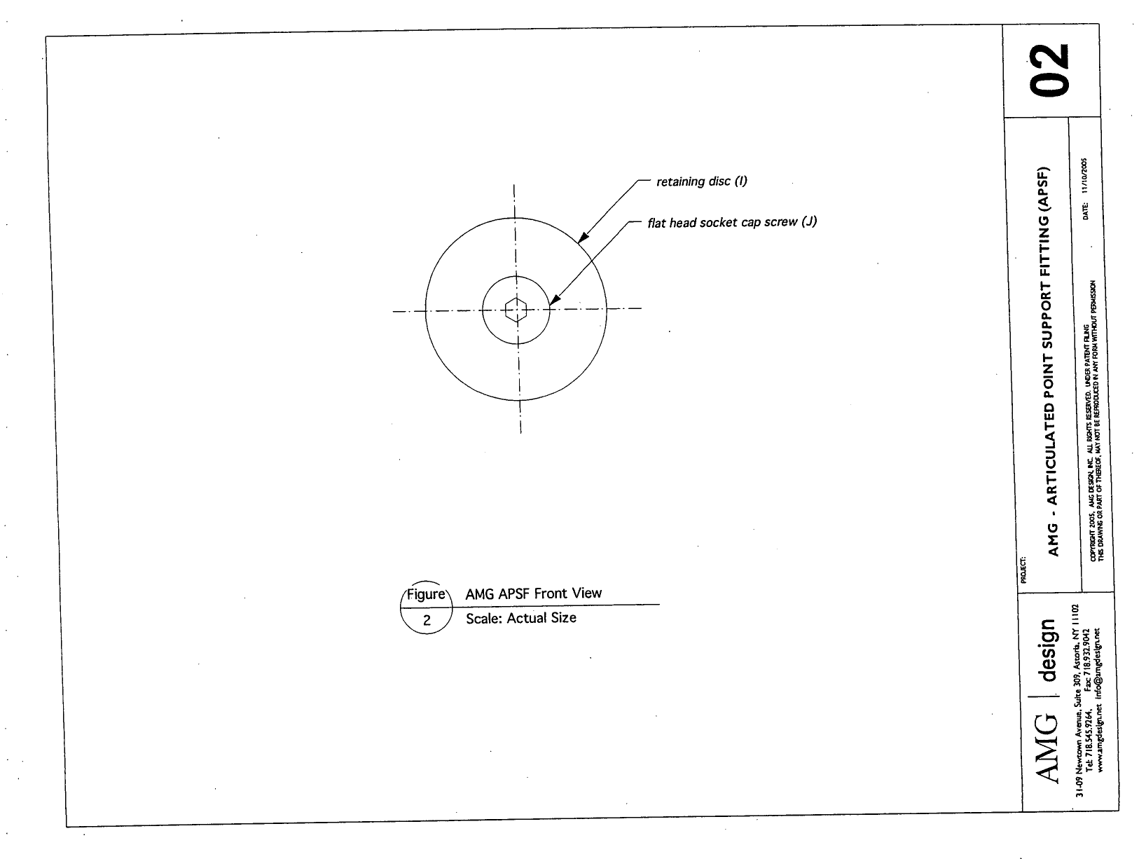

FIG. 2. Illustrate one embodiment of the retaining disc according to the present invention. Showing the stainless steel retainer disc with the fastener in place.

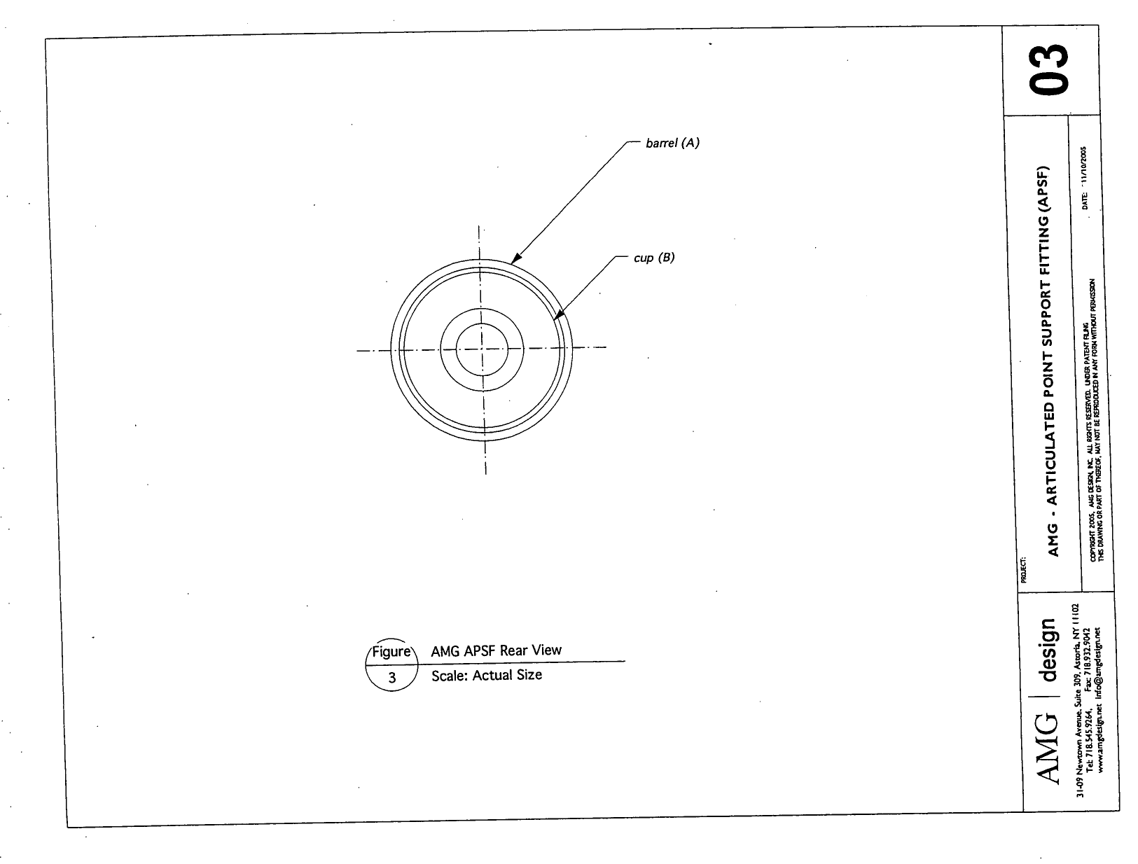

FIG. 3. Illustrates the rear view of the finish assembly. Showing the cup and barrel without the rear fastener in place.

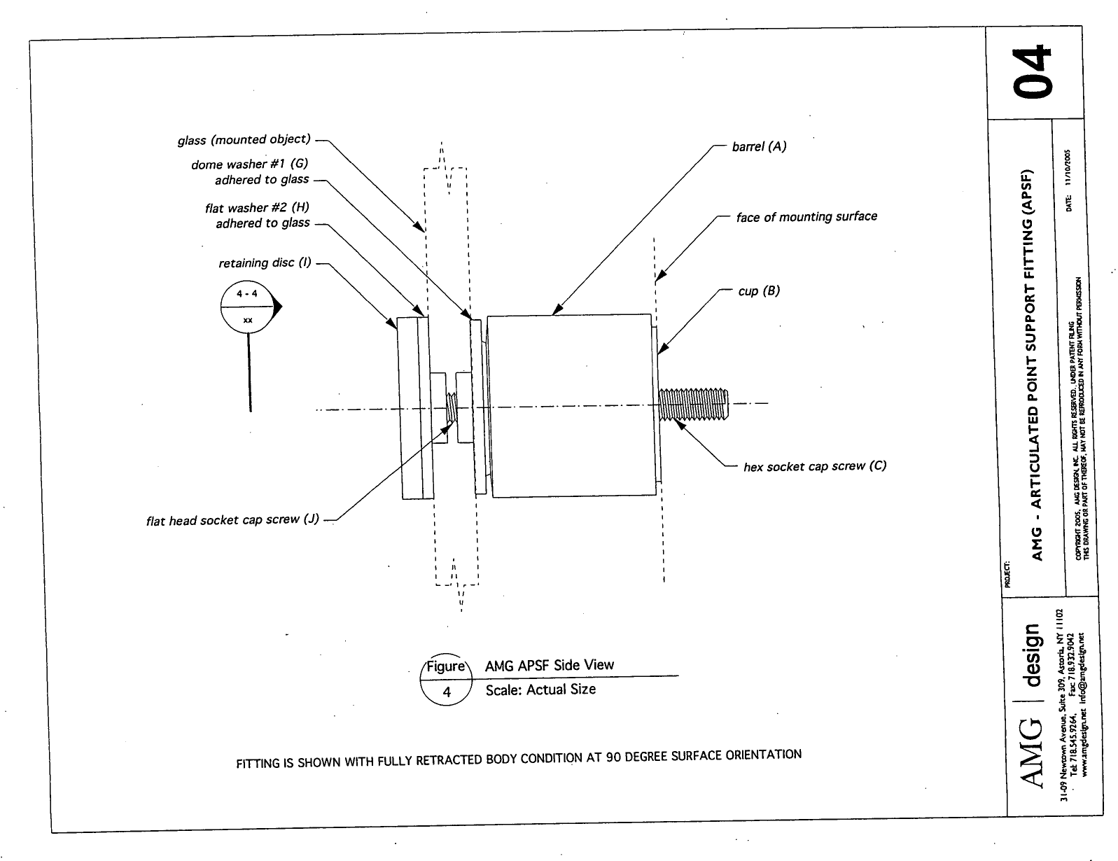

FIG. 4. Illustrates the top/side view (which is identical).

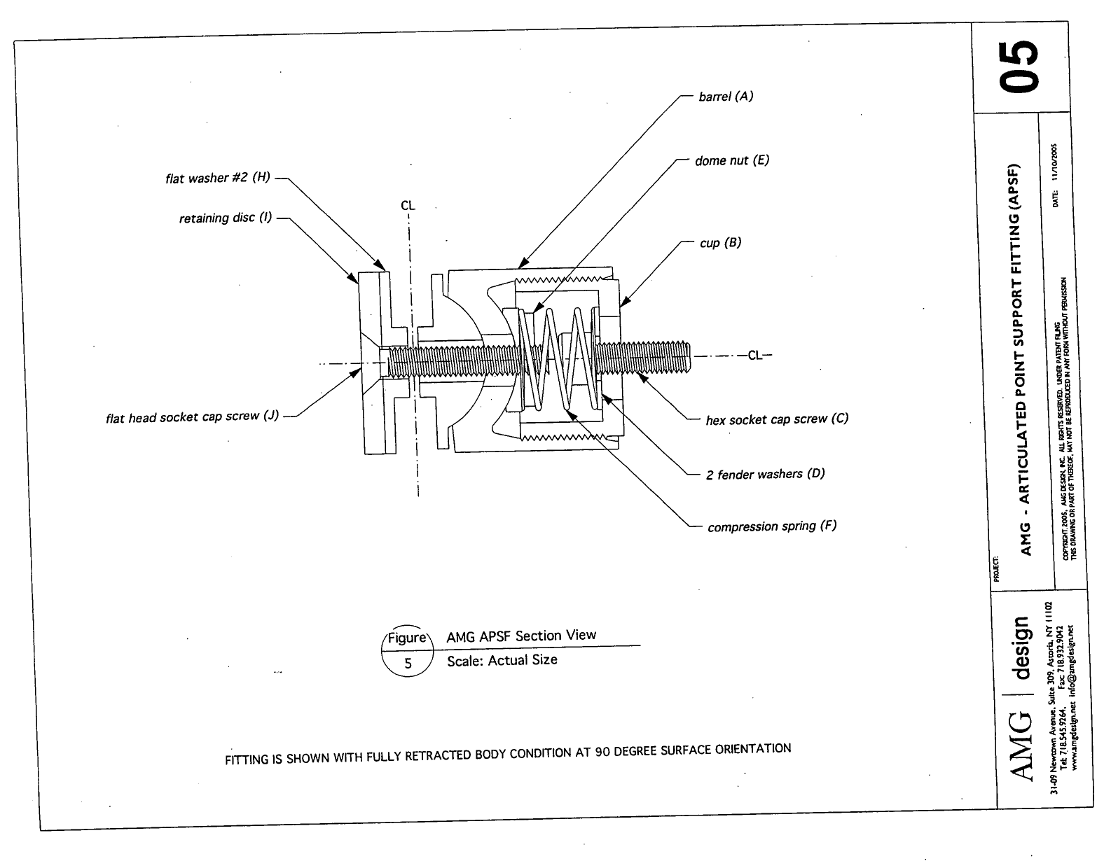

FIG. 5. Illustrates the cross section of the Articulated Point Support Fitting in a straight, retracted position.

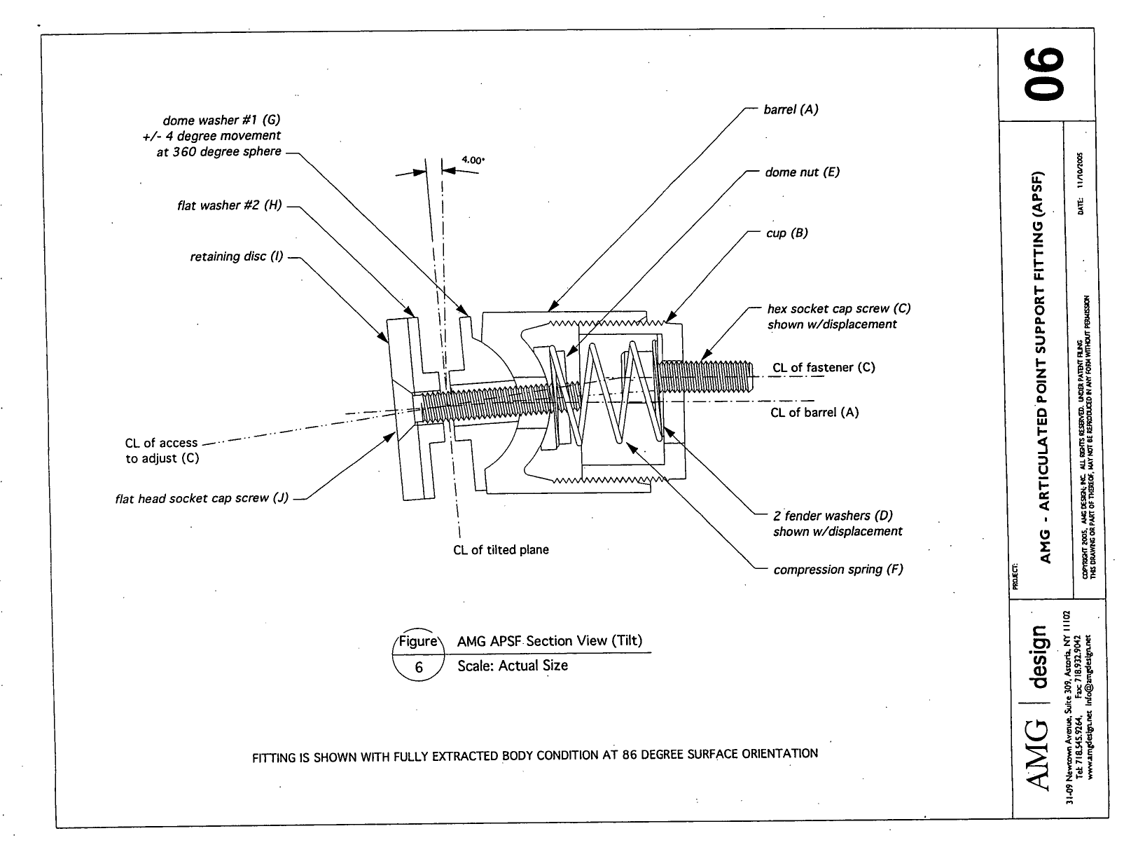

FIG. 6. Illustrates the cross section of the Articulated Point Support Fitting in a shifted displacement at the base cup and tilt adjustment at the mounted object/retainer plane.

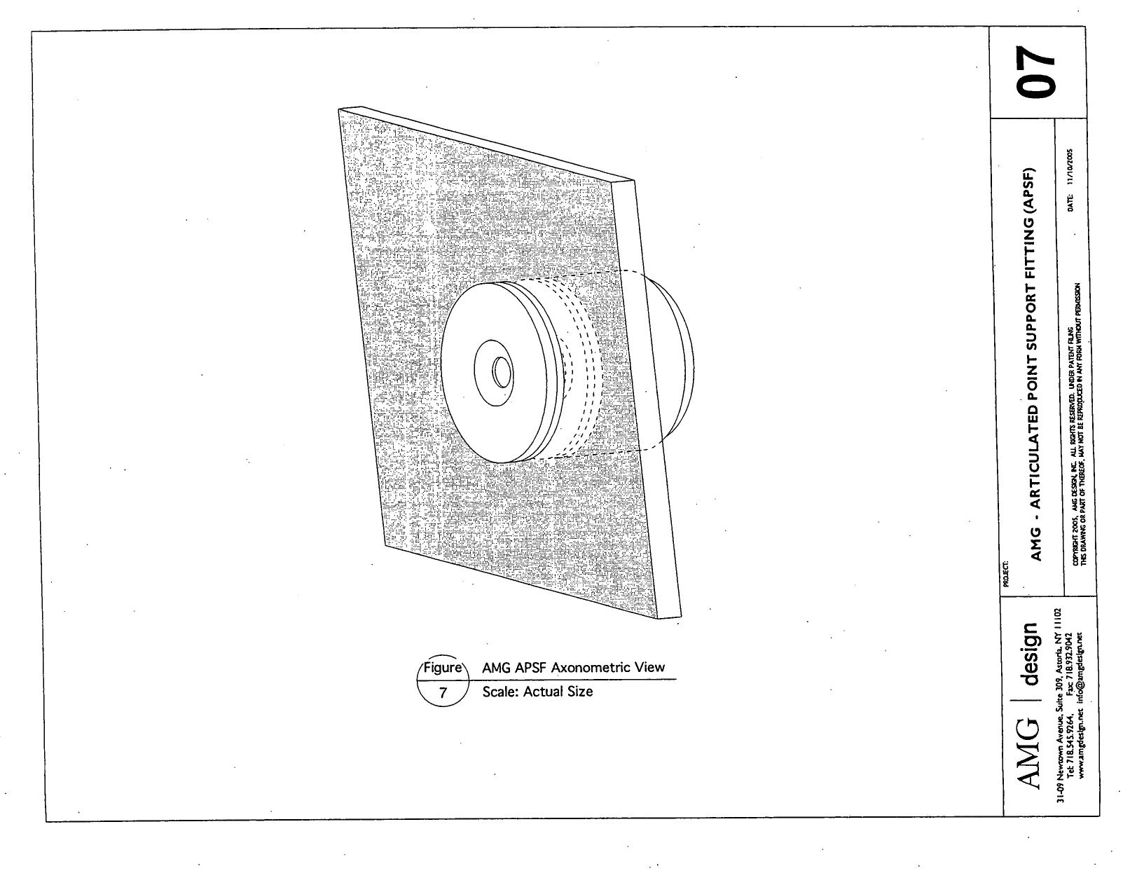

FIG. 7. Illustrates the axonometric view of the Articulated Point Support Fitting.

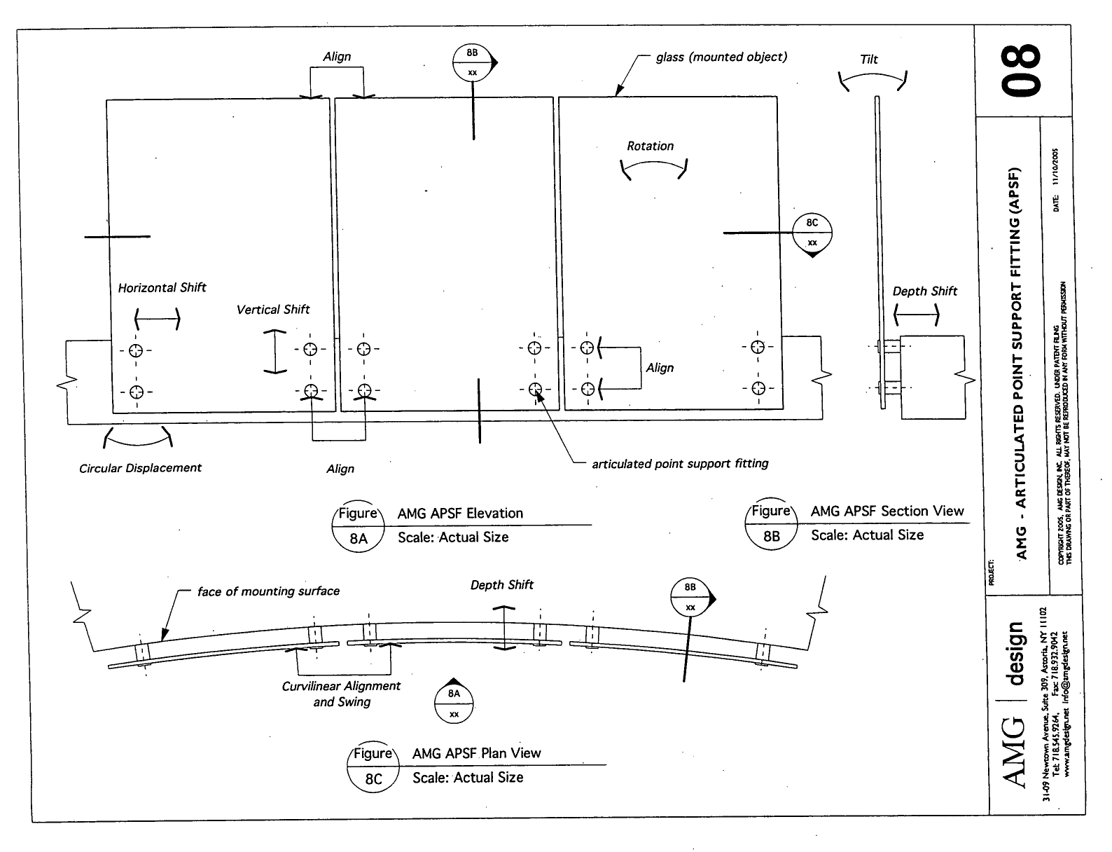

FIG. 8A. Illustrates the Articulated Point Support Fitting in an architectural application. An elevation of three consecutive glass panels positioned via the capabilities of the fitting thru shift and rotational adjustments.

FIG. 8B. Is sectional illustration of the fitting to adjust forward and backward tilt and depth adjustment (Z Axis).

FIG. 8C. Illustrates a plan view of the glass panels adjusted in a curvilinear position and swing and depth adjustment over the supporting structure.

It will also be understood that, in addition the Articulated Point Support Fitting, the device can be used to level objects such as machinery, wall claddings, partitions, and structural glazing elements in architectural applications.

It is further intended that any other embodiments of the present invention that result from any changes in application or method of use or operation, method of manufacture, shape, size, or material which are not specified within the detailed written description or illustrations contained herein yet are considered apparent or obvious to one skilled in the art are within the scope of the present invention.

1. In an articulated point support fitting, the improvements comprising:
a cup-like member at least having a base at one end for engagement with the support with a first hole therethrough and at least one side extending from the base to an opening at an opposite end;
a barrel having a base at one end for securing to the cup, an arcuate-surface portion at an opposite end that is convex and concave circularly arcuate in at least one direction transverse an axis of the barrel between the one and opposite ends thereof on axially opposite sides of the portion nearer and farther from the one end of the barrel, and a second hole through the arcuate-surface portion;
first fastener structure having a fastening portion with transverse dimensions less than of the first hole and a head structure having transverse dimensions greater than of the first hole for securing to the support through the first hole;
a dome washer having a surface complementary to the concave arcuate-surface portion of the barrel for rotational support thereon, an opposite surface for supporting one side of an article having a through hole of lesser transverse dimension than the dome washer, and a third hole through the dome washer from surface to surface,
whereby the first fastener structure may loosely secure the cup and barrel to the support while the article is adjusted against the opposite surface of the dome washer that rotates for accommodation of the engagement of the cup-like member with the support and the article with the dome washer, whereafter the first fastener structure may be tightened through the through hole of the article and the holes of the barrel and dome washer to fix the cup-like member on the support;
retaining structure or structures having transverse dimensions larger than the through hole of the article for engaging an opposite side of the article;
second fastener structure having a transverse dimension less than the through hole of the article and the holes of the barrel and dome washer;
a dome nut-like member having a concave surface for rotationally movable but binding engagement with the convex arcuate-surface portion of the barrel, a radius of curvature of the concave surface being slightly smaller than a radius of curvature of the convex arcuate-surface portion for the rotationally movable but binding engagement; and
a spring extending between the base of the cup and the dome nut-like member for maintaining the engagement thereof with the convex arcuate-surface portion,
whereby the second fastener structure may tighten on the article and bind the dome nut-like member to the concave surface after the first fastener structure has fixed the cup-like member to the support.

2. In an articulated point support fitting, the improvements comprising:
a member at least having a base at one end with a first hole therethrough for engaging a support and an opening at an opposite end;
a barrel having a base at one end for securing to the member, an arcuate-surface portion at an opposite end that is convex and concave circularly arcuate in at least one direction transverse an axis of the barrel on axially opposite sides nearer and farther from the one end of the barrel, and a second hole through the arcuate-surface portion;
first fastener structure having a fastening portion with transverse dimensions less than of the first hole and a head structure having transverse dimensions greater than of the first hole for securing to the support through the first hole;
a dome washer having one surface complementary to the concave arcuate-surface portion of the barrel for rotational support thereon, an opposite surface for supporting one side of an article, and a third hole through the dome washer from the one surface to the opposite surface,
whereby the first fastener structure may loosely secure the member and barrel to the support while the article is adjusted against the opposite surface of the dome washer that rotates for accommodation of the engagement of the member with the support and the article with the dome washer, whereafter the first fastener structure may be tightened through the second and third holes of the barrel and dome washer to fix the member on the support;
a retaining structure for engaging an opposite side of the article;
a second fastener structure having a transverse dimension less than the second and third holes of the barrel and dome washer;
a dome nut having a concave surface for rotationally movable but binding engagement with the convex side of the arcuate-surface portion of the barrel; and
a spring extending between the base of the member and the dome nut for maintaining the engagement thereof with the convex side of the arcuate-surface portion of the barrel,
whereby the second fastener structure may tighten the retaining structure on the article and bind the dome nut by engagement with the dome nut after the first fastener structure has fixed the member to the support.

3. The an articulated point support fitting according to claim 2, wherein one or more of:
the member is cup-shaped;
the axially opposite sides of the arcuate-surface portion are convex and concave spherical surfaces; and
a radius of curvature of the concave surface of the dome nut is slightly smaller than a radius of curvature of the convex side of the arcuate-surface portion for the rotationally movable but binding engagement.
